(19) United States
(12) Patent Application Publication
(10) Pub. No.: US 2006/0163241 A1
(43) Pub. Date: Jul. 27, 2006

(54) Scented wax heating device

(76) Inventor: Ming Ren Xiao, Dongguan (CN)

Correspondence Address: CHARLES E. BAXLEY, ESQ., 90 JOHN STREET, THIRD FLOOR, NEW YORK, NY, 10038, US

(21) Appl. No.: 11/042,728

(22) Filed: Jan. 24, 2005

(51) Int. Cl. F27D 11/00

(52) U.S. Cl. 219/438

(57) ABSTRACT

The present invention discloses a scented wax heating device, which includes a heating cylinder, an electric wire, and a ceramic heating piece installed at the bottom of the heating cylinder. The heating cylinder is installed in an insulating cylinder for an insulating effect, so that a user can freely move the heating device. The heating cylinder is filled with appropriate amount of water, and the scented wax is put into the heating cylinder. The heating cylinder is heated by the ceramic heating piece, so that the temperature of water in the heating cylinder rises to evenly vaporize the scented wax. The invention features a simple structure and a useful function.

### BACKGROUND OF THE INVENTION

1. Field of the Invention

The present invention generally relates to a scented wax heating device, and more particularly to an electric scented wax heating device that heats an essential oil or scented wax to produce an aromatic gas.

2. Description of the Related Art

As our living standard is improved day after day, people have a higher demand for better quality of life and living environment. For example, air refreshers, solid scents or essential oils are used to eliminate the peculiar smells in the air at home, in office, or in public places. The mentioned scented items are usually vaporized at room temperature to achieve the air refreshing effect. However, the effect of such evaporating method is generally affected by the change of temperature, humidity and air flow of the environment, and thus the extent of the vaporization of these scented items is affected accordingly.

There are some other electric scented wax heating devices in the market. With reference to FIG. 1, the heating device comprises a heater 1, and the heating device includes two handles 2 on the external surface of the heater 1, and the handles 2 are provided for facilitating users to move the heating device freely. A symmetric fixed arm 3 is transversally installed at the bottom of the heater 1, and a heating piece 4 is securely fixed by a screw 5, and the screw 5 passes through a positioning hole on a positioning plate 6, such that both ends of the positioning plate 6 press on the fixed arm 3 at the bottom of the heater 1. An electric wire 7 with a plug is connected to the heating piece 4. Different kinds of scented waxes are placed into the foregoing heater 1 directly for heating and vaporizing the scented wax. However, such structural design still has the following shortcomings: (1) After the scented wax is put into the heating device, the temperature of the heated scented wax at the bottom and at the top is not even during the heating process by the heating piece installed at the bottom, and thus resulting a poor effect on the vaporization of the scented wax; (2) the temperature of the external surface of the heating device is too high during the heating by the heating device, and thus in turn making the temperature of the handles too high as well, and users cannot move the heating device directly by hands, or users get burned very often or accidents occur frequently; (3) the heating piece easily falls off from the heater according to the foregoing method of connection, and thus a short circuit or an electric leak will occur easily.

### SUMMARY OF THE INVENTION

The primary objective of the present invention is to overcome the shortcomings of the prior arts by providing an electric heating device for heating an essential oil or a piece of scented wax to produce an aromatic gas. The simple structure of the invention can evenly vaporize the scented wax and provide a better effect for insulations.

To achieve the foregoing objective, the present invention adopts the technical solutions as described below:

A scented wax heating device comprises a heating cylinder, an electric wire, and a ceramic heating piece installed at the bottom of the heating cylinder. The heating cylinder is sleeved into an insulating cylinder for an insulating effect. The insulating cylinder could be cylindrical or in any other geometric shape. A chassis is disposed at the bottom of the insulating cylinder, and a through hole is disposed on the chassis. A U-shape fixing bracket is installed at the bottom of the heating cylinder, and the fixing bracket is soldered or secured by any other method onto the bottom of the heating cylinder, and a screw fixing hole is disposed on the fixing bracket. The heating piece is installed in the fixing bracket at the bottom of the heating cylinder, and a bolt presses on the heating piece, and the bolt passes through the fixing hole and the through hole on the chassis to couple the heating cylinder and the insulating cylinder. The bolt not only can fix the heating piece, but also can secure the heating cylinder onto the insulating cylinder.

The key point of the design of the present invention resides on that the heating cylinder of the scented wax heating device is sleeved into an insulating cylinder to achieve an insulating effect and facilitate users to freely move the heating device and effectively prevent the occurrence of accidents or burns. Further, appropriate amount of water is added into the heating cylinder, a piece of scented wax is placed into the heating cylinder, and the electric power is turned on to drive the ceramic heating piece to produce heat and heat up the water in the heating cylinder to a higher temperature. With the hot water surrounding the scented wax, the scented wax can be heated evenly so as to achieve the effect of producing an aromatic gas by an even vaporization of the scented wax. The heating piece according to the present invention is securely mounted onto the heating cylinder by means of the fixing bracket installed at the bottom of the heating cylinder, and such arrangement can effectively prevent the heating piece from becoming loosened and can assure the user's safety and the product's performance.

The above and other objects, features and advantages of the present invention will become apparent from the following detailed description taken with the accompanying drawings.

### BRIEF DESCRIPTION OF THE DRAWINGS

FIG. 1 is a schematic view of a scented wax heater according to a prior art;

FIG. 2 is an exploded view of a scented wax heater according to the present invention;

FIG. 3 is a schematic view of a partial structure of a scented wax heater according to the present invention; and

FIG. 4 is a schematic view of a whole structure of a scented wax heater according to the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

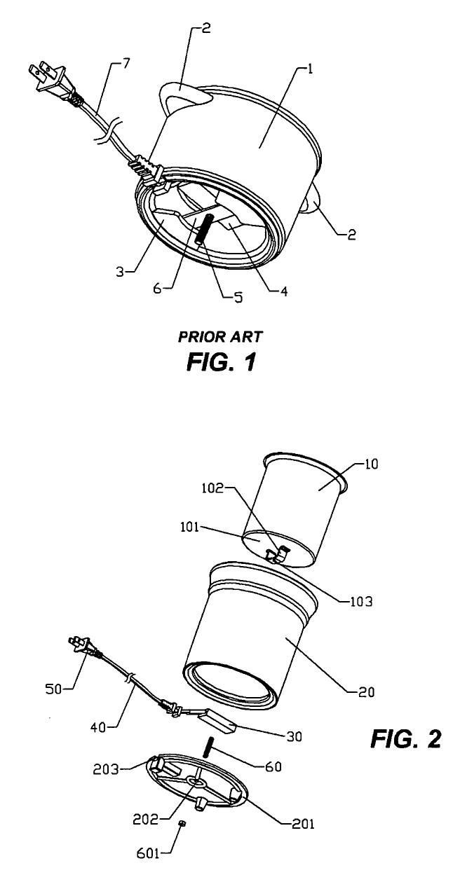

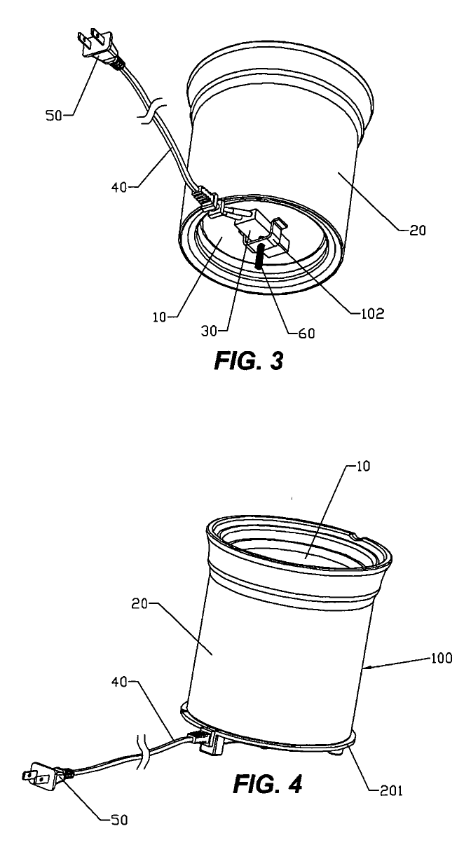

Please refer to FIGS. 1 to 4 for a preferred embodiment of the present invention. A scented wax heating device 100 comprises a heating cylinder 10, an electric wire 40 and a ceramic heating piece 30 installed at the bottom 101 of the heating cylinder 10. The heating cylinder 10 is sleeved into an insulating cylinder 20 for an insulating effect. The insulating cylinder 20 could be cylindrical or in any other geometric shape. A chassis 201 is disposed at the bottom of the insulating cylinder 20, and the chassis 201 includes a through hole 202. A U-shaped fixing bracket 102 is installed onto the bottom 101 of the heating cylinder 10, and the fixing bracket 102 is soldered or mounted by any other method onto the bottom of the heating cylinder 10. The fixing bracket 102 includes a screw fixing hole 103 disposed thereon, and the heating piece 30 is installed in the fixing bracket 102 at the bottom of the heating cylinder. One end of a bolt 60 presses on the heating piece 30, and the bolt 60 passes through the fixing hole 103 and the through hole 202 on the chassis 201 to connect the heating cylinder 10 with the insulating cylinder 20. With the fixing of a nut 601, the foregoing bolt 60 not only can fix the heating piece 30, but also can secure the heating cylinder and the insulating cylinder. One end of the aforementioned electric wire 40 is connected to the heating piece 30 and extended from a groove 203 disposed on the chassis 201 of the insulating cylinder 20 out of an external side of the insulating cylinder 20, and the other end of the electric wire 40 is connected to a plug 50.

The key point of the design of the present invention resides on that the heating cylinder 10 of the scented wax heating device 100 is sleeved into an insulating cylinder 20 to achieve the insulating effect and facilitate users to freely move the heating device 100 and effectively prevent the occurrence of accidents or burns. Further, appropriate amount of water is added into the heating cylinder 10; a piece of scented wax is placed into the heating cylinder 10; and the electric power is turned on to drive the ceramic heating piece 30 to produce heat and heat up the water in the heating cylinder 10 to a higher temperature. With the hot water surrounding the scented wax, the scented wax can be heated evenly so as to achieve the effect of producing an aromatic gas by an even vaporization of the scented wax. The heating piece 30 according to the present invention is securely mounted to the heating cylinder 10 by means of the fixing bracket 102 installed at the bottom of the heating cylinder 10, and such arrangement can effectively prevent the heating piece 30 from becoming loosened and can assure the user's safety and the product's performance.

Only a preferred embodiment of the present invention regarding a scented wax heating device has been described in the specification and illustrated in the drawings, but it should be pointed out that many other modifications are conceivable within the scope of the following claims.

What is claimed is:

1. A scented wax heating device, comprising: a heating cylinder; an electric wire; and a ceramic heating piece installed at the bottom of said heating cylinder; characterized in that said heating cylinder is sleeved into an insulating cylinder.

2. The scented wax heating device of claim 1, wherein said insulating cylinder is cylindrical or any other geometric shape.

3. The scented wax heating device of claim 1, wherein said insulating cylinder comprises a chassis disposed at the bottom of said insulating cylinder and said chassis has a through hole.

4. The scented wax heating device of claim 1, wherein said heating cylinder comprises a U-shape fixing bracket and a screw fixing hole disposed on said fixing bracket.

5. The scented wax heating device of claim 1, wherein said heating piece is installed in said fixing bracket at the bottom of said heating cylinder.

6. The scented wax heating device of claim 5, wherein said bolt passes through a fixing hole and said through hole on said chassis to couple said heating cylinder with said insulating cylinder.
